(19) United States
(12) Patent Application Publication
(10) Pub. No.: US 2025/0230779 A1
(43) Pub. Date: Jul. 17, 2025

(54) Piston Blank, Piston, And Method

(71) Applicant: KS Kolbenschmidt GmbH, Neckarsulm (DE)

(72) Inventors: Holger Germann, Heilbronn (DE); Gerhard Luz, Nordheim (DE); Edward Werninghaus, Bad Friedrichshall (DE)

(21) Appl. No.: 18/855,862

(22) PCT Filed: Mar. 15, 2023
(86) PCT No.: PCT/EP2023/056651

§ 371 Date: Oct. 10, 2024

(30) Foreign Application Priority Data
Apr. 13, 2022 (DE) 10 2022 108 997.5

(51) Int. Cl. F02F 3/22; C22C 38/04; C22C 38/22; C22C 38/28; C22C 38/34

(52) U.S. Cl. CPC F02F 3/22; C22C 38/04; C22C 38/22; C22C 38/28; C22C 38/34

(57) ABSTRACT

A piston blank (39) for a piston (8) for use in an internal combustion engine. The piston blank (39) is manufactured at least in sections from a steel alloy which includes a chromium content of 0.5 to 2 percent by weight and a silicon content of 2.5 to 3.5 percent by weight.

### CROSS-REFERENCE TO RELATED APPLICATION(S)

This application is filed pursuant to 35 U.S.C. § 371 claiming priority benefit to PCT/EP2023/056651 filed Mar. 15, 2023, which claims priority benefit to German Patent Application 102022108997.5 filed Apr. 13, 2022, the contents of both applications are incorporated by reference in the entirety for all purposes.

### TECHNICAL FIELD

The present invention relates to a piston blank for a piston, a piston comprising such a piston blank and a method for manufacturing such a piston using such a piston blank.

### BACKGROUND

Pistons for internal combustion engines can be made from steel alloys, such as the heat-treatable steel 42CrMo4 or the micro-alloyed steel 38MnVS6. Such pistons can either be made integrally or be composed of a piston lower part and a piston upper part, which can be joined together using a joining method. A piston of this type can be cooled by a jet of cooling oil, which is injected into a circumferential annular cooling canal of the piston with the help of an injection nozzle. This requires a certain minimum volume flow of cooling oil in order to keep highly stressed areas of the piston below a critical temperature for scaling of the piston via appropriate heat dissipation.

Due to their chemical composition, the aforementioned materials comprise a predetermined thermal conductivity that is similar for both materials. This results in a certain combustion chamber surface temperature depending on the design of the piston cooling system. This combustion chamber surface temperature cannot be increased further, as the aforementioned materials comprise limited resistance to scaling. A further increase in the combustion chamber surface temperature can lead to scaling-related cracking and thus to failure of the piston.

However, a higher combustion chamber surface temperature, i.e., hotter combustion caused by a reduction in heat loss to the piston crown of the piston, can in principle enable an increase in the thermodynamic efficiency of motor combustion. As a result, advantages in terms of fuel consumption and CO2 emissions can be realized. To date, increased requirements in terms of fuel consumption and CO2 reduction have often been met by developing friction-optimized piston systems. This involves, for example, optimized piston skirt profiles and installation clearances, as well as cost-intensive ring packs with special coatings or elaborate surface optimizations for cylinder liners.

WO 2014/198896 A1 describes a piston, in particular a steel piston, for an internal combustion engine with a piston crown which is part of a combustion chamber, wherein at least the piston crown comprises an oxidation protection layer.

### SUMMARY

Against this background, one task of the present invention is to provide an improved piston blank for a piston.

Accordingly, a piston blank for a piston is proposed. The piston blank is manufactured at least in sections from a steel alloy which comprises a chromium content of 0.5 to 2 percent by weight and a silicon content of 2.5 to 3.5 percent by weight.

The fact that the steel alloy comprises the aforementioned chromium and silicon content means that the steel alloy is particularly resistant to scaling. As a result, the combustion chamber surface temperature of a piston made from the piston blank can be increased without the piston scaling. This supplies an increase in thermodynamic efficiency during motor combustion. As a result, stricter requirements regarding fuel consumption and emissions, in particular CO2 emissions, can be met. In the present case, the “combustion chamber surface temperature” can be understood in particular as a temperature of a surface of a piston crown of the piston. Furthermore, the “combustion chamber surface temperature” can generally be understood as a temperature of a surface of a combustion chamber associated with the piston. The surface of the piston crown can be part of the combustion chamber.

The piston blank differs from the piston in that the piston is machined in comparison to the piston blank, for example by means of an ablative and/or forming manufacturing method. The piston blank can also differ from the piston in that a piston lower part of the piston blank and a piston upper part of the piston blank are not yet firmly connected to each other. In particular, the piston blank or the piston can be assigned a symmetry or middle axis to which the piston blank or the piston can be essentially rotationally symmetrical. This aforementioned middle axis can, in particular, be formed by a middle axis of a cylinder that envelops surfaces of a piston shaft of the piston and comprises a minimum diameter, with the middle axis of the cylinder being arranged perpendicular to a pin bore of the piston.

The piston blank or piston is also assigned a coordinate system with a width direction or x-direction, a height direction or y-direction and a depth direction or z-direction. The y-direction can also be referred to as the axial direction. The terms “y-direction” and “axial direction” can therefore be used interchangeably. The directions are oriented perpendicular to each other. The middle axis coincides with the y-direction or is oriented parallel to the y-direction. A radial direction is also assigned to the piston blank or the piston. The radial direction is oriented perpendicular to the middle axis and points away from it.

The steel alloy is preferably a so-called low-alloy steel alloy. The steel alloy can, for example, be formed into the piston blank as a semi-finished product using a forging method. The piston blank or the aforementioned piston lower part and the aforementioned piston upper part can therefore be forged components. However, this does not exclude the possibility that the piston blank may be machined using an ablative manufacturing method, such as milling, turning and/or eroding. Furthermore, the piston blank or the piston lower part and the piston upper part can also be cast components or cast components reworked by a forging method.

The fact that the piston blank is made of the steel alloy “at least in sections” means in particular that at least part of the piston blank can be made of the steel alloy. However, this does not exclude the possibility that the entire piston blank may be made of the steel alloy. In particular, the steel alloy is provided at least in the area of a combustion chamber bowl of the piston blank or the piston. In the event that the piston blank comprises a piston lower part and a piston upper part as mentioned above, only the piston upper part can be made of the steel alloy, for example.

Compared to the steel alloys 42CrMo4 or 38MnVS6 mentioned in detail, the steel alloy from which the piston blank is made comprises a lower thermal conductivity. This supplies less heat from the combustion chamber of an internal combustion engine with the piston during operation. This increases the combustion chamber surface temperature, which supplies an increase in the thermodynamic efficiency of motor combustion.

In addition, the alloy components chromium and silicon prevent scaling at the increased combustion chamber surface temperature. “Scaling” or “oxidation wear” can be understood here as the high-temperature corrosion of metals caused by direct chemical reaction with hot gases containing oxygen. Due to a reduction in the strength of steel alloys that are not or only slightly resistant to scaling, scaling can supply scaling-induced cracking and thus failure of the piston. This is reliably prevented with the help of the aforementioned alloy components of the steel alloy by significantly increasing the resistance to scaling. In addition to the elements iron, chromium and silicon, the steel alloy can contain the elements carbon, manganese, phosphorus, sulfur, molybdenum, titanium, lead, antimony, aluminum, nitrogen, copper, tin, nickel and boron. The steel alloy may also contain small amounts of oxygen and hydrogen.

According to one embodiment, the chromium content is 0.9 to 1.2 percent by weight and/or the silicon content is 2.85 to 3 percent by weight.

With this aforementioned chromium content and this silicon content, a particularly high resistance to scaling can be achieved.

According to another embodiment, the steel alloy comprises a carbon content of 0.35 to 0.5, in particular 0.4 to 0.44, percent by weight.

This low carbon content makes the steel alloy easy to form, which means that the piston blank can be produced and/or machined using a forging method.

According to another embodiment, the steel alloy comprises a manganese content of 0.5 to 0.9, in particular 0.6 to 0.8, percent by weight.

For example, one property of the manganese content in the steel alloy is that the hardenability of the steel alloy is increased.

According to another embodiment, the steel alloy comprises a titanium content of 0.005 to 0.015 percent by weight.

The titanium content gives the steel alloy high toughness, strength and ductility.

According to another embodiment, the steel alloy comprises a molybdenum content of 0.1 to 0.3, in particular 0.15 to 0.2, percent by weight.

The molybdenum content supplies the steel alloy with increased tempering resistance and high-temperature strength.

According to another embodiment, the steel alloy comprises a silicon content of 2.5 to 3.5, in particular 2.85 to 3, percent by weight.

As a result of solid solution strengthening, the silicon content supplies an increase in tensile strength and yield strength and, as a diffusion barrier for oxygen, increases the scaling resistance of the steel alloy.

According to another embodiment, the steel alloy comprises increased resistance to scaling at 550 to 650° C., in particular at 580 to 600° C.

“Resistance to scaling” or “scaling resistance” is understood here to mean resistance to scaling. The terms “resistance to scaling” and “scaling resistance” can be used interchangeably. The resistance to scaling can be determined by measuring a weight of the piston blank or piston or additionally by measuring a scale layer thickness, aging or annealing the piston blank or piston at a certain temperature, then measuring the weight of the piston blank or piston and finally determining a degree of oxidation based on a change in weight of the piston blank or piston. The increased resistance to scaling enables the piston to be used at higher temperatures, whereby the combustion chamber surface temperature can be increased with the aforementioned advantages.

According to another embodiment, the piston blank comprises a piston lower part and a piston upper part, wherein the piston upper part is made from the steel alloy, wherein the piston lower part is made from the steel alloy or from a further material which differs from the steel alloy, and wherein the further material comprises, in particular, a higher thermal conductivity than the steel alloy.

This means that preferably at least the piston upper part is formed from the steel alloy. The “thermal conductivity” or “thermal conductivity coefficient” is a material property that determines a heat flow through a material due to heat conduction. The lower the thermal conductivity, the better the thermal insulation. The other material can be, for example, the aforementioned heat-treated steel 42CrMo4 or the micro-alloyed steel 38MnVS6. The piston lower part and the piston upper part are joined together by a joining method. For example, the piston lower part and the piston upper part are materially bonded together to form an intermediate part of the piston from which the finished piston is manufactured. In materially bonded connections, the connecting partners are held together by atomic or molecular forces. Materially bonded connections are non-detachable connections that can only be separated again by destroying the connecting means and/or the connecting partners. For example, the piston lower part and the piston upper part are welded together, in particular friction-welded together. The intermediate part can be further machined using an ablative manufacturing method, in particular using a machining method, in order to form the piston from the intermediate part. Alternatively, or additionally, the piston upper part and the piston lower part can be positively connected to each other. A positive connection is created by two connecting partners engaging in or behind each other. For example, the piston lower part and the piston upper part can be screwed together.

According to another embodiment, the piston blank is an integral component that is made from the steel alloy throughout.

In this case, the piston blank does not comprise a separate piston lower part and a piston upper part. In this case, “integral” or “one-piece” means that the piston blank is not composed of different subcomponents but forms a single component. In particular, the piston blank can be designed as a single piece of material. “Single piece of material” means that the piston blank is made from the same material throughout, namely the steel alloy.

A piston with such a piston blank is also proposed.

As previously mentioned, the piston differs from the piston blank in that the lower part of the piston and the upper part of the piston are firmly connected to each other. The piston can also differ from the piston blank in that the piston blank is machined to form the piston. The machining can be carried out, for example, using a forging method and/or an ablative method, such as turning, milling, eroding or the like. The piston is part of the aforementioned internal combustion engine. The internal combustion engine may comprise a plurality of pistons.

According to one embodiment, the piston comprises a combustion chamber bowl and a cooling canal running at least in sections around the combustion chamber bowl, wherein an average first wall thickness of a first wall provided between the combustion chamber bowl and the cooling canal is greater than 5 percent, preferably greater than 6 percent, preferably greater than 7 percent, of a piston diameter of the piston.

The combustion chamber bowl can already be formed on the piston blank, in particular on the piston upper part. The combustion chamber bowl can be formed and/or reworked using an ablation method or a forging method. The cooling canal runs in a ring around the middle axis of the piston. A cooling oil, in particular engine oil, can be passed through the cooling canal to dissipate heat from the piston. The cooling oil can, for example, be injected into the cooling canal through holes provided on the piston using an injection nozzle. The fact that the first wall thickness is greater than 5 percent of the piston diameter means that the dissipation of heat by the cooling oil can be further reduced in the area of the combustion chamber bowl. This supplies an additional increase in the combustion chamber surface temperature and thus the thermodynamic efficiency. According to internal company knowledge, a respective wall thickness between the cooling canal and the combustion chamber bowl as well as between an inner form of the piston and the combustion chamber bowl is usually designed at 3.5 percent of the piston diameter. By increasing the wall thickness to more than 5 percent of the piston diameter, the heat dissipation can be reduced. Furthermore, an increase in the combustion chamber surface temperature and thermodynamic efficiency can also be achieved by adapting the geometry, in particular the cross-sectional geometry, of the cooling canal. In this case, the cooling canal can be equipped with a smaller cross-sectional geometry compared to cooling canals known internally, which also reduces the dissipation of heat from the combustion chamber bowl. This measure is also advantageous in terms of the dimensions and overall height of the piston. Alternatively, the cooling canal can be designed as an open cooling canal, which is injected with cooling oil via a freely accessible inner surface with the help of the injection nozzle. Alternatively, the piston can be designed without any cooling canal at all. As a further measure, the amount of cooling oil used to cool the piston can be reduced. This also increases the combustion chamber surface temperature and thus the thermodynamic efficiency. There is also an additional efficiency advantage, as the power loss of a required oil pump is reduced, which leads to an indirect contribution to fuel savings. In the present case, the “piston diameter” is to be understood as the diameter of a smallest cylinder that encloses a so-called piston skirt of the piston. The first wall thickness of the first wall is defined in particular as the smallest distance between the combustion chamber bowl, in particular a rounding of the combustion chamber bowl, and the cooling canal, in particular a wall of the cooling canal.

According to another embodiment, the average first wall thickness is at least 5 millimeters.

In the present case, the “average” first wall thickness is to be understood in particular as meaning that the first wall thickness, viewed along its direction of extension or main direction of extension, is at least 5 millimeters on average or is greater than 5 percent of the piston diameter. The “direction of extension” or “main direction of extension” can be understood to mean a direction along which the first wall comprises its greatest geometric extent. In particular, the “direction of extension” or “main direction of extension” can mean a course of the first wall along a surface of the combustion chamber bowl. This surface can be referred to as the combustion chamber bowl surface. This means that the first wall thickness can be less than the aforementioned 5 percent of the piston diameter or 5 mm in some areas or locally. However, viewed over the entire direction of extension or main direction of extension of the first wall, i.e., globally, the first wall thickness is on average at least 5 millimeters or the first wall thickness is greater than 5 percent of the piston diameter. The terms “direction of extension” and “main direction of extension” can be used interchangeably in the present case.

According to another embodiment, an average second wall thickness of a second wall provided between the combustion chamber bowl and an inner form of the piston is greater than 5 percent, preferably greater than 6 percent, particularly preferably greater than 7 percent, of the piston diameter.

The combustion chamber bowl preferably comprises a combustion chamber bowl bottom facing the combustion chamber and an inner form facing away from the combustion chamber. The combustion chamber bowl bottom and the inner form can each be conical or cone shaped. Facing the combustion chamber, the second wall forms the combustion chamber bowl bottom. Facing away from the combustion chamber, the second wall forms the inner form. The first wall and the second wall merge into one another. The second wall thickness of the second wall is defined in particular as a smallest distance between the combustion chamber bowl, in particular the combustion chamber bowl bottom of the combustion chamber bowl, and the inner form. The first wall merges into the second wall, in particular at the aforementioned rounding of the combustion chamber bowl, or vice versa. This means, in particular, that the first wall is connected to the second wall.

According to another embodiment, the average second wall thickness is at least 5 millimeters.

Here too, the second wall can be less than the second wall thickness of at least 5 millimeters or 5 percent of the piston diameter in some areas or locally. On average, however, the second wall thickness is always greater than 5 millimeters or at least 5 percent of the piston diameter. Here, too, it is particularly true that the second wall thickness, viewed along an extension direction or main extension direction of the second wall, is on average at least 5 millimeters or is at least 5 percent of the piston diameter. The use of the steel alloy with low thermal conductivity supplies a reduction in the heat dissipation from the combustion chamber bowl to the cooling canal and thus an increase in the temperature of a surface of the combustion chamber bowl and the combustion chamber. The design measures, such as increasing the wall thickness of the walls, adapting the geometry of the cooling canal and/or reducing the amount of cooling oil, comprise an analogous effect, supplying a higher combustion chamber surface temperature by reducing the dissipation of heat. As a result, the thermodynamic efficiency of combustion can be increased and thus fuel consumption reduced. CO2 emissions can also be reduced. The prerequisite for this is sufficient resistance to scaling. In addition to the low thermal conductivity, the alloy components of the steel alloy supply increased resistance to scaling. This means that a limit temperature above which technically relevant scaling occurs can be shifted to a higher temperature. As a result of the high scaling resistance of the steel alloy, additional combustion-side measures can also be taken to increase the combustion chamber surface temperature and increase the thermodynamic efficiency. The thermodynamic efficiency of the internal combustion engine can be significantly increased by using the steel alloy, which is highly resistant to scaling and at the same time comprises low thermal conductivity, at least for the piston upper part and/or in the area of the combustion chamber bowl. As a result, consumption advantages and a reduction in CO2 emissions can be realized. The constantly increasing requirements of legislation and the market can thus be met. Ever stricter limits with regard to exhaust gas, fuel consumption and emissions, especially CO2 emissions, can be complied with.

Furthermore, a method for manufacturing such a piston blank is proposed, wherein the piston blank is made from a steel alloy which comprises a chromium content of 0.5 to 2 percent by weight and a silicon content of 2.5 to 3.5 percent by weight.

The piston blank can be a cast component. The piston blank can also be a forged component. Furthermore, the piston blank can also be a cast component that is reworked using a forging method. In the method, the piston lower part and the piston upper part can be manufactured separately. The piston lower part and the piston upper part are firmly joined together, in particular welded together, to form the aforementioned intermediate part or piston. To form the piston from the intermediate part, the intermediate part can be machined using an ablating and/or forming manufacturing method.

The embodiments and features described for the proposed piston blank apply mutatis mutandis to the proposed piston and the proposed method, and vice versa.

In this case, “one” is not necessarily to be understood as being limited to exactly one element. Rather, several elements, such as two, three or more, can also be provided. Any other counting word used here is also not to be understood as meaning that there is a restriction to exactly the specified number of elements. Rather, numerical deviations upwards and downwards are possible, unless otherwise stated.

Further possible implementations of the piston blank, the piston and/or the method also include combinations of features or embodiments described above or below with regard to the embodiment examples that are not explicitly mentioned. The person skilled in the art will also add individual aspects as improvements or additions to the respective basic form of the piston blank, the piston and/or the method.

Further advantageous embodiments and aspects of the piston blank, the piston and/or the method are the subject of the subclaims and of the embodiments of the piston blank, the piston and/or the method described below. Furthermore, the piston blank, the piston and/or the method are explained in more detail by means of preferred embodiments with reference to the attached figures.

### BRIEF DESCRIPTION OF THE DRAWINGS

FIG. 1 shows a schematic side view of one embodiment of a vehicle;

FIG. 2 shows a schematic sectional view of one embodiment of a piston for an internal combustion engine;

FIG. 3 shows an enlarged detailed view in the area III according to FIG. 2;

FIG. 4 shows a schematic perspective cutaway view of the piston according to FIG. 2;

FIG. 5 shows a schematic sectional exploded view of one embodiment of a piston blank for the piston according to FIG. 2;

FIG. 6 shows a schematic sectional view of an intermediate part for the piston according to FIG. 2; and

FIG. 7 shows a schematic block diagram of one embodiment of a method for manufacturing the piston blank according to FIG. 2.

### DETAILED DESCRIPTION

In the figures, identical or functionally identical elements have been given the same reference symbols, unless otherwise stated.

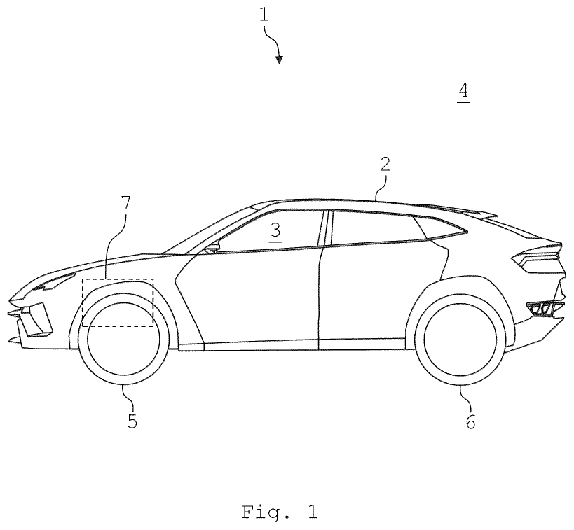

FIG. 1 shows a schematic side view of one embodiment of a vehicle 1. The vehicle 1 is a motor vehicle, in particular a passenger car. The vehicle 1 can also be a utility vehicle, for example a truck, a harvester or a construction machine. Furthermore, the vehicle 1 can also be a military vehicle. In addition, the vehicle 1 can also be an aircraft, a watercraft or a rail vehicle. In the following, however, it is assumed that the vehicle 1 is a motor vehicle, in particular a passenger car.

The vehicle 1 comprises a car body 2 which encloses a passenger compartment or vehicle interior 3 of the vehicle 1. The vehicle interior 3 can accommodate a driver and passengers. The car body 2 delimits a surroundings 4 of the vehicle 1 from the vehicle interior 3. The vehicle interior 3 is accessible from the surroundings 4 by means of doors.

The vehicle 1 comprises a chassis with several wheels 5, 6. The number of wheels 5, 6 is basically arbitrary. Preferably, the vehicle 1 comprises four wheels 5, 6. However, the vehicle 1 may, for example, comprise six wheels 5, 6. The wheels 5, 6 are part of a chassis of the vehicle 1. Only two wheels 5, 6 can be driven. However, all wheels 5, 6 can also be driven. In this case, the vehicle 1 is a four-wheel drive vehicle.

The vehicle 1 comprises a combustion engine or internal combustion engine 7. The internal combustion engine 7 can be a diesel engine or a gasoline engine. The vehicle 1 can be powered purely by the internal combustion engine 7. However, the vehicle 1 can also be a hybrid vehicle. In this case, the vehicle 1 comprises at least one electric motor in addition to the internal combustion engine 7. The internal combustion engine 7 comprises an engine block and a plurality of pistons accommodated in piston bores in the engine block. For example, the internal combustion engine 7 may comprise three, four, five, six or more than six pistons.

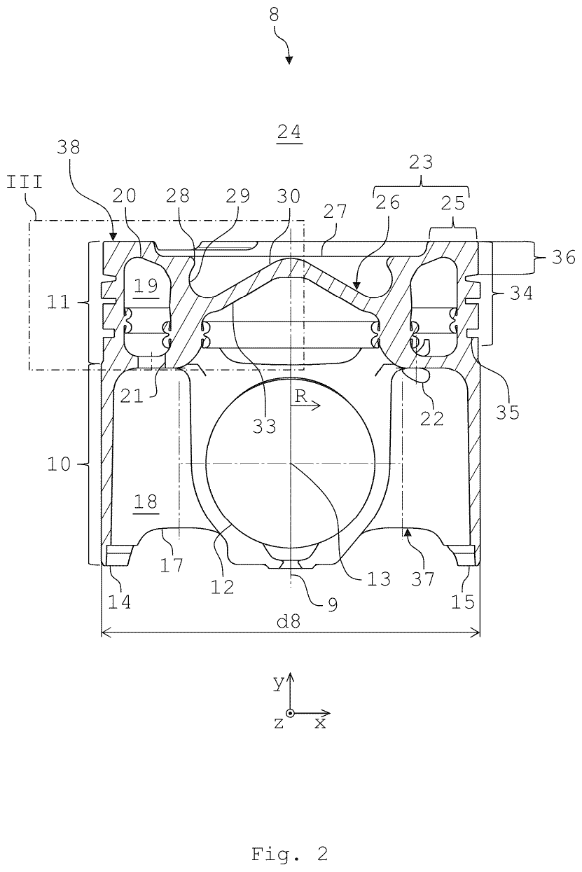

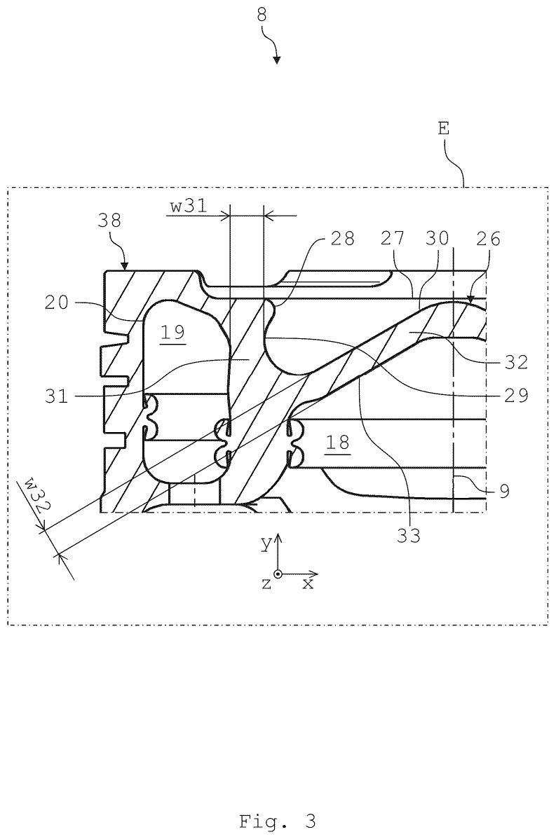

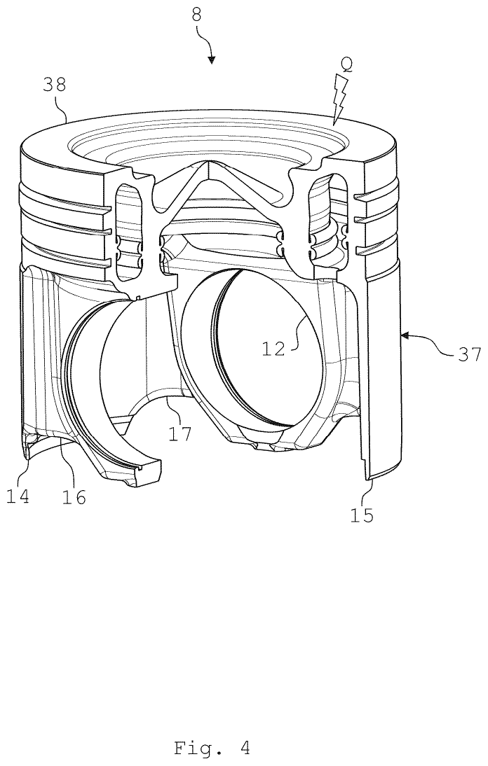

FIG. 2 shows a schematic sectional view of one embodiment of a piston 8 for the internal combustion engine 7. FIG. 3 shows the detailed view III according to FIG. 2. FIG. 4 shows a schematic perspective partial sectional view of the piston 8. In the following, reference is made to FIGS. 2 to 4 simultaneously.

The piston 8 can be part of a vehicle 1 as previously explained, in particular the internal combustion engine 7. However, the piston 8 is particularly preferably part of a utility vehicle. In this case, the vehicle 1 is a utility vehicle. The internal combustion engine 7 and thus the piston 8 can be used in any vehicle 1, ship, machine or the like. Furthermore, the internal combustion engine 7 or the piston 8 can also be used for stationary applications, such as for generators, power, heat or the like.

The piston 8 can comprise an axis of symmetry or middle axis 9, to which the piston 8 can be essentially rotationally symmetrical. A coordinate system with a width direction or x-direction x, a height direction or y-direction y and a depth direction or z-direction z is assigned to the piston 8. The y-direction y can also be referred to as the axial direction. The terms “y-direction” and “axial direction” can therefore be used interchangeably. The directions x, y, z are oriented perpendicular to each other. In particular, the middle axis 9 coincides with the y-direction y or is oriented parallel to it. A radial direction R is also assigned to the piston 8. The radial direction R is oriented perpendicular to the middle axis 9 and points away from it.

The piston 8 comprises a piston foot or piston shaft 10 and a piston head 11. Viewed along the middle axis 9, the piston shaft 10 is arranged below the piston head 11. The piston shaft 10 comprises a piston hub with a pin bore 12, in which an undisplayed pin for coupling the piston 8 to an undisplayed connecting rod of the internal combustion engine 7 can be accommodated. A symmetry or middle axis 13 of the pin bore 12 intersects the middle axis 9 or is offset from it. Furthermore, the middle axis 13 is oriented perpendicular to the middle axis 9. The middle axis 13 coincides with the z-direction z or is oriented parallel to it.

In the orientation shown in FIG. 2, a shaft section 14, 15 is provided on both sides of the piston hub. A first shaft section 14 and a second shaft section 15 are provided. The shaft sections 14, 15 can be cylindrical in shape in sections. In other words, the shaft sections 14, 15 may form part of a cylinder which is rotationally symmetrical with respect to the middle axis 9. The shaft sections 14, 15 together form a so-called piston skirt of the piston 8. The shaft sections 14, 15 can be constructed in sections rotationally symmetrical to the middle axis 9. In particular, however, the shaft sections 14, 15 do not form a complete cylinder. One of the shaft sections 14, 15 forms a pressure side of the piston 8, with the other of the shaft sections 14, 15 forming a counter-pressure side of the piston 8.

The shaft sections 14, 15 are connected to each other by means of wall sections 16, 17. A first wall section 16 and a second wall section 17 are provided. The radial direction R points outwards away from the middle axis 9 in the direction of the shaft sections 14, 15. The pin bore 12 breaks through the wall sections 16, 17. The shaft sections 14, 15 and the wall sections 16, 17 enclose an interior 18 of the piston shaft 10. The interior 18 is open at the bottom in the orientation shown in FIGS. 2 to 4. The previously mentioned pin for coupling the piston 8 to the connecting rod runs along the middle axis 13 through the interior 18.

The piston 8 comprises a cooling canal 19 that runs completely around the middle axis 9 and is preferably rotationally symmetrical to it. In particular, the cooling canal 19 is torus shaped. The cooling canal 19 comprises a wall 20, which defines a geometry or a cross-sectional geometry of the cooling canal 19. A cooling oil, in particular engine oil, can be passed through the cooling canal 19 in order to dissipate heat Q introduced into the piston 8 during operation. For this purpose, the cooling oil can be injected into the cooling canal 19 with the aid of an injection nozzle arranged below the piston 8 in the orientation shown in FIGS. 2 to 4.

The cooling canal 19 is in fluid connection with the interior 18 by means of several bores 21, 22. The number of bores 21, 22 is basically arbitrary. Preferably, several bores 21, 22 are provided, which can be evenly distributed around the middle axis 9. The bores 21, 22 can also be arranged unevenly distributed around the middle axis 9. For example, during operation of the piston 8 in the orientation of FIGS. 2 to 4, cooling oil can be injected into the interior 18 from below with the aid of the aforementioned injection nozzle. At least part of the cooling oil passes through the bores 21, 22 into the cooling canal 19 and out of it again. The cooling oil is then used to dissipate heat Q from the piston 8.

The piston head 11 comprises a piston crown 23, which faces a cylinder head of the internal combustion engine 7. A large part of the heat Q is also introduced into the piston crown 23. In particular, the piston crown 23 faces a combustion chamber 24 of the internal combustion engine 7. The piston crown 23 comprises an annular piston crown section 25, which spans a plane oriented perpendicular to the middle axis 9. Furthermore, the piston crown 23 comprises a combustion chamber bowl 26, which is set back with respect to the piston crown section 25. Viewed along the middle axis 9 or along the y-direction y, the combustion chamber bowl 26 is thus offset or recessed with respect to the piston crown section 25.

The combustion chamber bowl 26 can comprise any geometry. In the present case, the combustion chamber bowl 26 comprises a shoulder 27 running around the middle axis 9, which is set back relative to the piston crown section 25 when viewed along the y-direction y. A combustion chamber bowl edge 28 of the combustion chamber bowl 26 projects radially into the combustion chamber bowl 26 when viewed against the radial direction R. The combustion chamber bowl edge 28 is adjoined by a rounding 29 running around the middle axis 9. The rounding 29 merges into a, in particular conical or cone-shaped, combustion chamber bowl bottom 30, which extends upwards when viewed along the y-direction y. However, the combustion chamber bowl bottom 30 ends below the shoulder 27 when viewed along the y-direction y.

A first wall 31 (FIG. 3) is provided between the combustion chamber bowl 26 and the cooling canal 19. The first wall 31 fluidically separates the cooling canal 19 from the combustion chamber bowl 26. The first wall 31 runs completely around the middle axis 9. The first wall 31 comprises a first wall thickness w31. The first wall thickness w31 is at least 5 mm. In particular, an average of the first wall thickness w31 over the entire first wall 31 is at least 5 mm. This means that the first wall 31 can also comprise a smaller first wall thickness w31 than 5 mm in some areas or locally. However, viewed along a main direction of extension of the first wall 31, in the present case the y-direction y, the first wall thickness w31 is always at least 5 mm on average. In the present case, the “main direction of extension” is to be understood as a direction, in the present case the y-direction y, along which the first wall 31 comprises its greatest geometric extent.

A second wall 32 (FIG. 3) separates the combustion chamber bowl 26 from the interior 18. The second wall 32 forms the combustion chamber bowl bottom 30 on the front side. On the rear side, i.e., facing the interior 18, the second wall 32 forms a so-called inner form 33 of the piston 8. The inner form 33 can be conical or cone shaped. The second wall 32 comprises a second wall thickness w32. The second wall thickness w32 is also at least 5 mm. In particular, an average of the second wall thickness w32 over the entire second wall 32 is at least 5 mm. This means that the second wall 32 can also comprise a smaller second wall thickness w32 than 5 mm in some areas or locally. However, viewed along a main direction of extension of the second wall 32, in the present case the x-direction x, the second wall thickness w32 is always at least 5 mm on average.

The piston 8 comprises a piston diameter d8. The piston diameter d8 is defined as the diameter of the smallest possible cylinder that encloses the piston skirt, i.e., the shaft sections 14, 15. This cylinder is oriented perpendicular to the middle axis 13. The first wall thickness w31 is at least on average greater than 5% of the piston diameter d8. Preferably, the first wall thickness w31 is at least on average greater than 6% of the piston diameter d8. Particularly preferably, the first wall thickness w31 is at least on average greater than 7% of the piston diameter d8. However, the first wall thickness w31 is at least 5 mm on average. The second wall thickness w32 is also at least on average greater than 5% of the piston diameter d8. Preferably, the second wall thickness w32 is at least on average greater than 6% of the piston diameter d8. Particularly preferably, the second wall thickness w32 is at least on average greater than 7% of the piston diameter d8. However, the second wall thickness w32 is at least 5 mm on average.

Any number of sectional planes E (FIG. 3) can be laid through the middle axis 9. The middle axis 9 lies in each of these sectional planes E. For each sectional plane E, it applies in particular that the first wall thickness w31 and/or the second wall thickness w32 is on average at least 5%, preferably 6%, more preferably 7%, of the piston diameter d8 or/and is at least 5 mm. For example, the average wall thicknesses w31, w32 can each be calculated separately from one another. The respective average wall thickness w31, w32 can be calculated along a sectional contour of the first wall 31 and/or the second wall 32 located in the respective sectional plane E with a constant step size or a constant increment of no more than 1 mm. In particular, the wall thicknesses w31, w32 are calculated along a line formed by the aforementioned sectional contour, which is formed by a section of the sectional plane E with surfaces of the combustion chamber bowl 26 and the piston crown section 25.

The first wall thickness w31 of the first wall 31 is defined in particular as a smallest distance between the combustion chamber bowl 26, in particular the rounding 29, and the cooling canal 19, in particular the wall 20 of the cooling canal 19. The second wall thickness w32 of the second wall 32 is defined in particular as a smallest distance between the combustion chamber bowl 26, in particular the combustion chamber bowl bottom 30, and the inner form 33. The first wall 31 merges into the second wall 32 at the rounding 29 or vice versa. In particular, this means that the first wall 31 is connected to the second wall 32.

A ring section or ring field 34 is provided on the piston head 11. In particular, the ring field 34 forms an essentially cylindrical outer surface of the piston head 11, which can be rotationally symmetrical to the middle axis 9. The ring field 34 comprises several annular grooves 35 arranged one above the other along the y-direction y, of which only one is provided with a reference sign in FIG. 2. The annular grooves 35 are suitable for receiving piston rings. For example, two or three such annular grooves 35 are provided. A fire land 36 adjoining the piston crown 23 is part of the ring field 34. However, the fire land 36 does not comprise an annular groove 35 for receiving a piston ring as mentioned above.

The piston 8 is in two parts and comprises a piston lower part 37 and a piston upper part 38. The piston lower part 37 and the piston upper part 38 are two separate components which are joined together in a material bonded manner to form the piston 8. In materially bonded connections, the connecting partners are held together by atomic or molecular forces. Materially bonded connections are non-detachable connections that can only be separated again by destroying the connecting means and/or the connecting partners. Material bonding can be achieved, for example, by gluing, soldering or welding. For example, the piston lower part 37 is welded, in particular friction-welded, to the piston upper part 38.

The piston 8 is intended to achieve a higher combustion chamber surface temperature in the combustion chamber 24, i.e., hotter combustion, compared to pistons known internally. By increasing the combustion chamber surface temperature, it is possible to increase the thermodynamic efficiency of motor combustion. As a result, advantages in terms of fuel consumption and CO2 emissions can be realized.

In the case of known pistons, in particular known steel pistons, either a heat-treatable steel 42CrMo4 or a micro-alloyed steel 38MnVS6 can be used as materials, for example. These pistons can either be designed integrally or comprise a piston lower part and a piston upper part, which are joined together by a joining operation. The entire piston is usually made of the same material, even in two-piece concepts.

This type of piston is cooled by a jet of cooling oil, which is injected by an injection nozzle into a circumferential, annular cooling canal. This requires a certain minimum volume flow of cooling oil in order to keep the highly stressed areas, in particular the combustion chamber bowl edge, below the critical temperature for scaling of the piston by means of appropriate heat dissipation. Both of the above-mentioned materials 42CrMo4 and 38MnVS6 comprise a thermal conductivity that is determined by their chemical composition and is similar for both materials. This results in a certain combustion chamber surface temperature with standard piston cooling. This cannot be increased further, as both materials comprise limited resistance to scaling, which means that an increase in the combustion chamber surface temperature could supply scaling-related cracking and thus piston failure.

The increasing requirements regarding the reduction of fuel consumption and CO2 emissions are therefore often met with the development of friction-optimized piston systems. For example, optimized piston skirt profiles and installation clearances, as well as cost-intensive ring packs with special coatings such as amorphous carbon (diamond-like carbon, DLC) or elaborate surface optimizations for cylinder liners are used. The reduction in fuel consumption and CO2 emissions is to be improved with the help of the piston 8 explained above.

For this purpose, a steel alloy with high resistance to scaling and low thermal conductivity is used, at least for the area of the combustion chamber bowl 26 of the piston 8. Due to the lower thermal conductivity, this increases the combustion chamber surface temperature even with standard piston cooling, which supplies an increase in the thermodynamic efficiency of motor combustion.

A low-alloy steel alloy with the following chemical composition is particularly suitable for the piston 8:
Carbon C: 0.35 to 0.5 percent by weight, in particular 0.4 to 0.44 percent by weight.
Silicon Si: 2.5 to 3.5 percent by weight, in particular 2.85 to 3 percent by weight.
Chromium Cr: 0.5 to 2 percent by weight, in particular 0.9 to 1.2 percent by weight.
Manganese Mn: 0.5 to 0.9 percent by weight, in particular 0.6 to 0.8 percent by weight.
Titanium Ti: 0.005 to 0.015 percent by weight.
Molybdenum Mo: 0.1 to 0.3 percent by weight, in particular 0.15 to 0.2 percent by weight.

In addition to other alloy components, the steel alloy mainly comprises the element iron Fe. The steel alloy exhibits increased resistance to scaling at 550 to 650° C., in particular at 580 to 600° C.

In the event that the piston 8 is an integral component and is thus not divided into the piston lower part 37 and the piston upper part 38, the entire piston 8 is made of this steel alloy. In the event that the piston 8 is in two parts and comprises the piston upper part 38 separate from the piston lower part 37, only the piston upper part 38, which comprises the combustion chamber bowl 26, can be made of the steel alloy. The tempered steel 42CrMo4 or the micro-alloyed steel 38MnVS6 are then preferably used for the piston lower part 37.

The increase in the combustion chamber surface temperature can be further increased by design measures by reducing the cooling effect in the area of the combustion chamber bowl 26. This is possible because the steel alloy can withstand a higher surface temperature in the combustion chamber bowl 26 due to its higher resistance to scaling without causing the piston 8 to fail. This increase in the combustion chamber surface temperature can be achieved by the measures described above, which can be combined with one another. On the one hand, by increasing the wall thicknesses w31, w32 in the area of the combustion chamber bowl 26, the dissipation of heat Q by the cooling oil is further reduced and thus supplies an additional increase in the combustion chamber surface temperature and thus the thermodynamic efficiency.

By adapting the geometry of the cooling canal 19, an increase in the combustion chamber surface temperature and thermodynamic efficiency can also be achieved. In this case, the cooling canal 19 can be equipped with a smaller cross-section compared to known pistons, whereby the dissipation of heat Q is reduced. In addition, this measure is advantageous with regard to the dimensions and the overall height of the piston 8. Alternatively, the cooling canal 19 can be designed as an open cooling canal, which is injected with the cooling oil via a freely accessible inner surface. Furthermore, it is also possible to dispense with the cooling canal 19 completely.

Furthermore, the amount of cooling oil used to cool the piston 8 can be reduced. This also increases the combustion chamber surface temperature and thus the thermodynamic efficiency. There is also an additional efficiency advantage, as the power loss of an oil pump for pumping the cooling oil is reduced, which supplies an indirect contribution to fuel savings.

The use of the steel alloy with low thermal conductivity supplies a reduction in the dissipation of heat Q from the combustion chamber bowl 26 to the cooling canal 19 and thus to an increase in the surface temperature of the combustion chamber bowl 26 and the combustion chamber 24. The steel alloy comprises a thermal conductivity that is around 20 W/m*K lower than that of the materials 42CrMo4 or 38MnVS6. Simulations have shown that a combustion chamber bowl edge temperature at the combustion chamber bowl edge 28 increases by 2 K for every 1 W/m*K reduction in thermal conductivity.

The additional design measures listed above, such as increasing the wall thicknesses w31, w32, adapting the cooling canal geometry of cooling canal 19 or reducing the amount of cooling oil, have an analogous effect, leading to a higher combustion chamber surface temperature by reducing the dissipation of heat Q. As a result, the thermodynamic efficiency of combustion can be increased, and fuel and CO2 emissions can be saved. The prerequisite for this is sufficient resistance to scaling of the steel alloy.

In addition to its low thermal conductivity, the steel alloy is also highly resistant to scaling, which means that a limit temperature above which technically relevant scaling occurs can be shifted by at least 70 K to a higher temperature. As a result of the high scaling resistance of the steel alloy, additional combustion-side measures can also be taken to increase the combustion chamber surface temperature and to increase the thermodynamic efficiency.

The thermodynamic efficiency of the internal combustion engine 7 can be increased by using the steel alloy, which is highly resistant to scaling and at the same time comprises low thermal conductivity, at least as the material for the piston upper part 38. As a result, consumption advantages and advantages in terms of CO2 emissions can be realized.

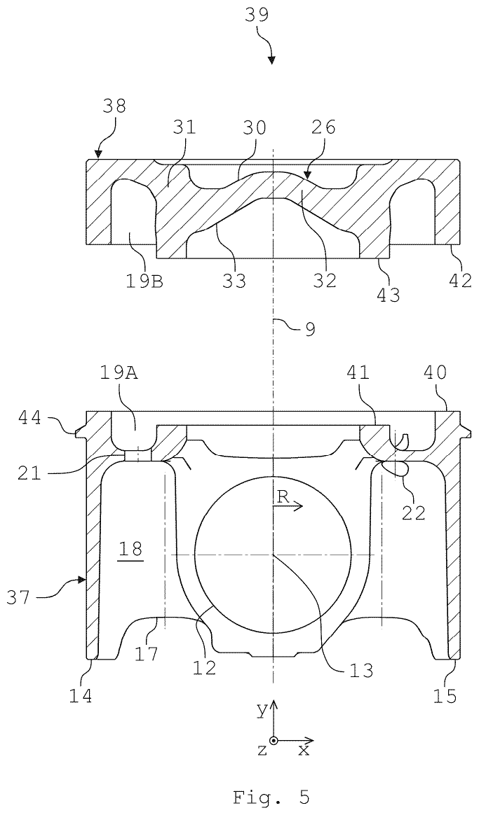

FIG. 5 shows a schematic sectional exploded view of an embodiment of a piston blank 39 for the piston 8.

The piston blank 39 can be used to manufacture the piston 8. The piston blank 39 comprises a piston lower part 37, as mentioned above, and a piston upper part 38, as mentioned above. The piston blank 39 differs from the piston 8 in that the piston lower part 37 is not yet connected to the piston upper part 38. The piston blank 39 can also differ from the piston 8 in that the piston 8 is machined after the piston lower part 37 has been welded to the piston upper part 38. Suitable machining processes include eroding, milling, turning or the like. Furthermore, the piston blank 39 can also be formed to form the piston 8 using a forming manufacturing method, for example a forging method.

The middle axis 9 can be assigned to the piston blank 39. The aforementioned coordinate system with the directions x, y, z can also be assigned to the piston blank 39. Furthermore, the radial direction R can also be assigned to the piston blank 39.

The cooling canal 19 is formed partly on the piston lower part 37 and partly on the piston upper part 38. In particular, a first cooling canal section 19A is provided on the piston lower part 37. A second cooling canal section 19B may be provided on the piston upper part 38. The cooling canal sections 19A, 19B together form the cooling canal 19. The piston upper part 38 comprises the combustion chamber bowl 26, which can be machined to produce the piston 8 from the piston blank 39 using an ablating or forming manufacturing method to produce the final geometry of the combustion chamber bowl 26 shown in FIGS. 2 to 4.

As previously mentioned, the piston lower part 37 and the piston upper part 38 are two separate components which can be joined together by a material bond, in particular welded together. For this purpose, the piston lower part 37 comprises a first joining surface 40 running annularly around the middle axis 9 and a second joining surface 41 running annularly around the middle axis 9. Viewed along the radial direction R, the second joining surface 41 is positioned within the first joining surface 40. Accordingly, the piston upper part 38 comprises a first joining surface 42 extending annularly around the middle axis 9 and a second joining surface 43 extending annularly around the middle axis 9. Viewed along the radial direction R, the second joining surface 43 is placed inside the first joining surface 42.

The piston lower part 37 may further comprise a circumferential shoulder 44 which, when viewed along the radial direction R, extends radially out of the piston lower part 37. The shoulder 44 is optional. The piston lower part 37 and the piston upper part 38 are each integral, in particular single piece of material, components. “Integral” or “one-piece” in the present case means that the piston lower part 37 and the piston upper part 38 are not each composed of different subcomponents, but each form a single component.

At least the piston upper part 38 is made, at least in sections, from the aforementioned highly scale-resistant steel alloy. In particular in the area of the combustion chamber bowl 26, the piston upper part 38 is made of the steel alloy. The piston lower part 37 can, for example, be made of the materials 42CrMo4 or 38MnVS6. Alternatively, however, the piston lower part 37 can also be made from the same highly scale-resistant steel alloy from which the piston upper part 38 is made. The piston blank 39 can also be an integral component. In this case, the piston lower part 37 and the piston upper part 38 are not two separate components that are subsequently joined together. The piston blank 39 is then made from the highly scaling-resistant steel alloy throughout.

“Single piece of material” means that the piston lower part 37 and the piston upper part 38 are each made from the same material throughout. The piston 8 itself or the piston blank 39, on the other hand, consists of several parts. The piston lower part 37 is preferably a cast component. The piston upper part 38 can also be a cast component. Furthermore, the piston lower part 37 can also be a forged component. The piston upper part 38 can also be a forged component. In the event that the piston lower part 37 and/or the piston upper part 38 are each a cast component, they can be reworked using a forging method. However, the piston lower part 37 and/or the piston upper part 38 may also be manufactured or machined using an ablative manufacturing method.

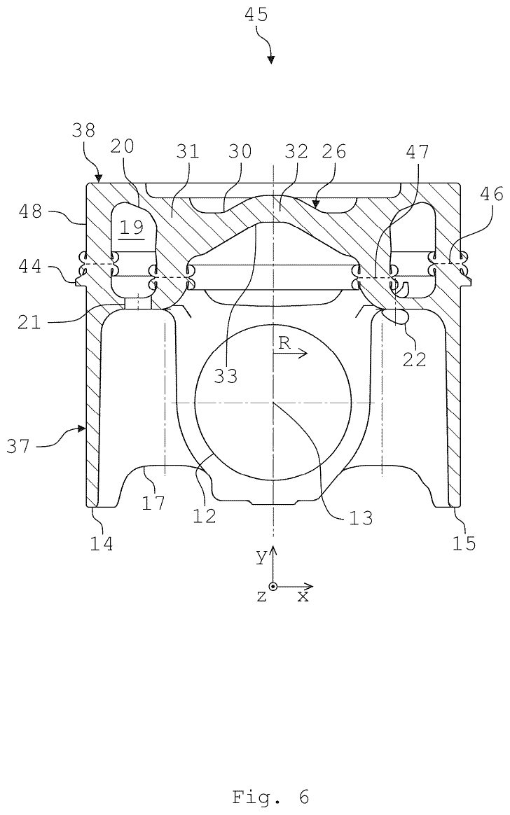

FIG. 6 shows a schematic sectional view of an intermediate part 45 for the piston 8.

To form the intermediate part 45, the piston lower part 37 and the piston upper part 38 are joined together at their joining surfaces 40 to 43, forming joining planes 46, 47. The joining planes 46, 47 can be welding seams, in particular friction welding seams. The first joining surfaces 40, 42 and the second joining surfaces 41, 43 are each firmly connected to one another. The intermediate part 45 differs from the piston blank 39 in that the piston lower part 37 is firmly connected, in particular welded, to the piston upper part 38. Friction welding, for example, is a suitable welding method.

The piston 8 differs from the intermediate part 45 in that, unlike the intermediate part 45, the piston 8 is post-machined using an ablative and/or forming manufacturing method. For example, to produce the piston 8 from the intermediate part 45, the combustion chamber bowl 26 is machined, the ring field 34 is formed onto the intermediate part 45, the shoulder 44 is removed and protruding beads of the joining plane 46 are removed. Furthermore, a cylindrical outer surface 48 of the intermediate part 45 can be machined to produce the ring field 34.

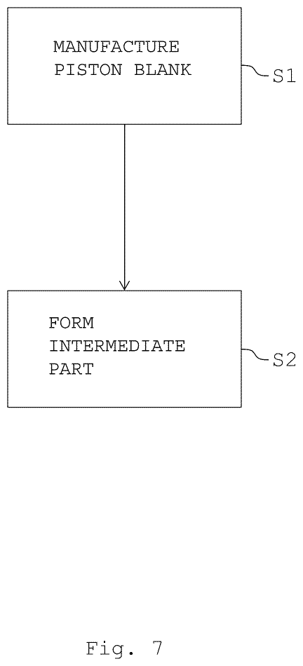

FIG. 7 shows a schematic block diagram of one embodiment of a method for manufacturing the piston blank 39.

In the method, in a step S1, the piston blank 39 is manufactured from the steel alloy, which comprises a chromium content of 0.5 to 2 percent by weight and a silicon content of 2.5 to 3.5 percent by weight. Step S1 may comprise casting, forming and/or machining the steel alloy. Furthermore, in step S1, the piston lower part 37 and the piston upper part 38 can be manufactured as separate components. In this case, at least the piston upper part 38 is manufactured from the steel alloy. Alternatively, the piston blank 39 can also be manufactured as an integral component in step S1. In this case, the piston lower part 37 and the piston upper part 38 are not two separate components.

The method can comprise a step S2, in which the piston lower part 37 and the piston upper part 38 are joined or assembled to form the intermediate part 45. In the case where the piston lower part 37 and the piston upper part 38 are joined together, the piston lower part 37 and the piston upper part 38 are joined to each other at the joining surfaces 40 to 43 in a materially bonding manner, in particular welded. Preferably, the piston lower part 37 and the piston upper part 38 are friction-welded together at the joining surfaces 40 to 43.

Although the present invention has been described with reference to examples of embodiments, it can be modified in many ways.

### LIST OF REFERENCE SIGNS

1 Vehicle
2 Car body
3 Vehicle interior
4 Surroundings
5 Wheel
6 Wheel
7 Internal combustion engine
8 Pistons
9 Middle axis
10 Piston shaft
11 Piston head
12 Pin bore
13 Middle axis
14 Shaft section
15 Shaft section
16 Wall section
17 Wall section
18 Interior
19 Cooling canal
19A Cooling canal section
19B Cooling canal section
20 Wall
21 Bore
22 Bore
23 Piston crown
24 Combustion chamber
25 Piston crown section
26 Combustion chamber bowl
27 Shoulder
28 Combustion chamber bowl edge
29 Rounding
30 Combustion chamber bowl bottom
31 Wall
32 Wall
33 Inner form
34 Ring field
35 Annular groove
36 Fire land
37 Piston lower part
38 Piston upper part
39 Piston blank
40 Joining surface
41 Joining surface
42 Joining surface
43 Joining surface
44 Shoulder
45 Intermediate part
46 Joining plane
47 Joining plane
48 Outer surface
d8 Piston diameter
E Sectional plane
Q Heat
R Radial direction
S1 Step
S2 Step
w31 Wall thickness
w32 Wall thickness
x x-direction
y y-direction
z z-direction

1. A piston blank for a piston, wherein the piston blank is manufactured at least in sections from a steel alloy comprising:
a chromium content of 0.5 to 2 percent by weight; and
a silicon content of 2.5 to 3.5 percent by weight.

2. The piston blank according to claim 1, wherein the chromium content is 0.9 to 1.2 percent by weight or the silicon content is 2.85 to 3 percent by weight.

3. The piston blank according to claim 1, wherein the steel alloy comprises a carbon content of 0.35 to 0.5 percent by weight.

4. The piston blank according to claim 1, wherein the steel alloy comprises a manganese content of 0.5 to 0.9 percent by weight.

5. The piston blank according to claim 1, wherein the steel alloy comprises a titanium content of 0.005 to 0.015 percent by weight.

6. The piston blank according to claim 1, wherein the steel alloy comprises a molybdenum content of 0.1 to 0.3 percent by weight.

7. The piston blank according to claim 1, the steel alloy comprises an increased resistance to scaling at 550 to 650° C.

8. The piston blank according to 1, wherein the piston blank comprises:
a piston lower part; and
a piston upper part made from the steel alloy, wherein the piston lower part is made from a further material having a higher thermal conductivity than the steel alloy.

9. The piston blank according to claim 1, wherein the piston blank is an integral component made from the steel alloy throughout.

10. (canceled)

11. A piston comprising the piston blank according to claim 1, the piston further comprising:
a combustion chamber bowl; and
a cooling canal running at least in sections around the combustion chamber bowl, wherein an average first wall thickness of a first wall provided between the combustion chamber bowl and the cooling canal is greater than 5 percent, of a piston diameter of the piston.

12. The piston according to claim 11, wherein the average first wall thickness (w31) is at least 5 millimeters.

13. The piston according to claim 11, wherein an average second wall thickness of a second wall provided between the combustion chamber bowl and an inner form of the piston is greater than 5 percent of the piston diameter.

14. The piston according to claim 13, wherein the average second wall thickness is at least 5 millimeters.

15. (canceled)

16. The piston blank according to claim 1, wherein the chromium content is 0.9 to 1.2 percent by weight and the silicon content is 2.85 to 3 percent by weight.

17. A piston blank for use in a piston of an internal combustion engine, the piston blank made from a steel alloy comprising:
a chromium content of 0.5 to 2 percent by weight;
a silicon content of 2.5 to 3.5 percent by weight;
a carbon content of 0.35 to 0.5 percent by weight;
a manganese content of 0.5 to 0.9 percent by weight;
a titanium content of 0.005 to 0.015 percent by weight; and
a molybdenum content of 0.1 to 0.3 percent by weight.

18. The piston blank of claim 17, wherein
the chromium content of 0.9 to 1.2 percent by weight;
the silicon content of 2.85 to 3 percent by weight;
the carbon content of 0.4 to 0.44 percent by weight;
the manganese content of 0.6 to 0.8 percent by weight; and
the molybdenum content of 0.15 to 0.2 percent by weight.

19. The piston blank according to claim 17, further comprising:
a combustion chamber bowl having a combustion chamber surface configured to be in communication with a combustion chamber, wherein the chromium content and the silicon content are operable to allow for a higher combustion chamber surface temperature and a resistance to scaling of the combustion chamber surface.

20. The piston blank of claim 19, further comprising:
a cooling canal running at least in sections around the combustion chamber bowl, wherein an average first wall thickness of a first wall provided between the combustion chamber bowl and the cooling canal is greater than 5 percent of a piston diameter of the piston, and wherein an average second wall thickness of a second wall provided between the combustion chamber bowl and an inner form of the piston is greater than 5 percent of the piston diameter, wherein the average first wall thickness and the average second wall thickness are configured to reduce heat dissipation through the first wall and the second wall providing the higher combustion chamber surface temperature.

21. The piston blank of claim 20, wherein the average first wall thickness is at least 5 millimeters, and the average second wall thickness is at least 5 millimeters.

22. The piston blank of claim 20, wherein the average first wall thickness is greater than 7 percent of the piston diameter, and the second wall thickness is greater than 7 percent of the piston diameter.
